(19) United States
(12) Patent Application Publication
(10) Pub. No.: US 2023/0366618 A1
(43) Pub. Date: Nov. 16, 2023

(54) ELECTRONIC LOCK REFRIGERATION ASSEMBLY

(71) Applicants: Jaimee Williams, Reynoldsburg, OH (US); Jared Williams, Reynoldsburg, OH (US)

(72) Inventors: Jaimee Williams, Reynoldsburg, OH (US); Jared Williams, Reynoldsburg, OH (US)

(21) Appl. No.: 17/743,089

(22) Filed: May 12, 2022

(51) Int. Cl. F25D 29/00; F25D 13/04; F25D 23/02

(52) U.S. Cl. CPC F25D 29/006; F25D 13/04; F25D 23/028

(57) ABSTRACT

An electronic lock refrigeration assembly for storage of food includes a refrigeration unit. The refrigeration unit has a peripheral surface and a back surface. A plurality of doors is positioned on the peripheral surface of the refrigeration unit. Each of the doors has a key pad and a handle. Additionally, each of the doors has a cavity. The plurality of doors encloses the cavity of each of the doors. A locking system is positioned on the peripheral surface of the refrigeration unit. The locking system includes a screen and a pay pad. The screen is a computer of the locking system. The screen allows the user to select an open locker to use. The pay pad is an electronic payment pad. The pay pad is in electric communication with the screen.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### 1 Field of the Invention.

The disclosure relates to refrigerated locker devices and more particularly pertains to a new refrigerated locker device for storage of food.

### 2 Description of Related Art Including Information Disclosed Under 37 CFR 1.97 and 1.98.

The prior art relates to refrigerated locker devices. The prior art relates to a variety of refrigerated locker devices including an electronic locking mechanism. Furthermore, known prior art includes a variety of refrigerated locker devices comprising a plurality of lockers. Known prior art lacks a refrigerated locker device having a plurality of lockers with electronic locking mechanisms to be used by a payment system.

### (H) BRIEF SUMMARY OF THE INVENTION

An embodiment of the disclosure meets the needs presented above by generally comprising a refrigeration unit having a refrigeration system. The refrigeration unit has a peripheral surface and a back surface. A plurality of doors is positioned on the peripheral surface of the refrigeration unit. Each of the doors has a key pad and a handle. Additionally, each of the doors has a cavity. The plurality of doors is configured for enclosing the cavity of each of the doors. A locking system is positioned on the peripheral surface of the refrigeration unit. The locking system includes a screen and a pay pad. The screen is configured for being a computer of the locking system. The screen is configured for allowing the user to select an open locker to use. The pay pad is an electronic payment pad. The pay pad is in electric communication with the screen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front view of an electronic lock refrigeration assembly according to an embodiment of the disclosure.

FIG. 2 is a back view of an embodiment of the disclosure.

FIG. 3 is a side view of an embodiment of the disclosure.

FIG. 4 is an isometric in-use view of an embodiment of the disclosure.

### (J) DETAILED DESCRIPTION OF THE INVENTION

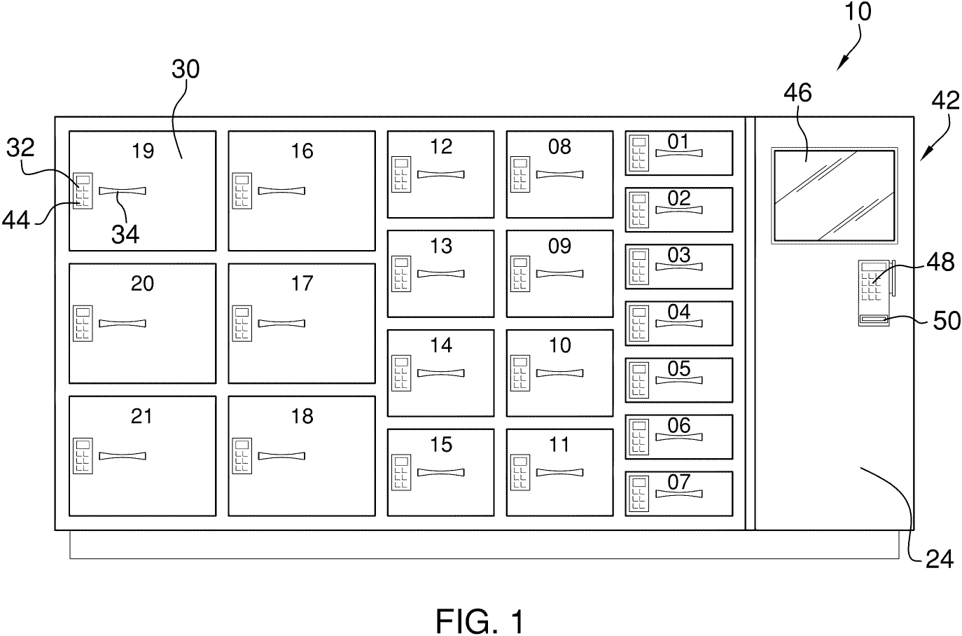

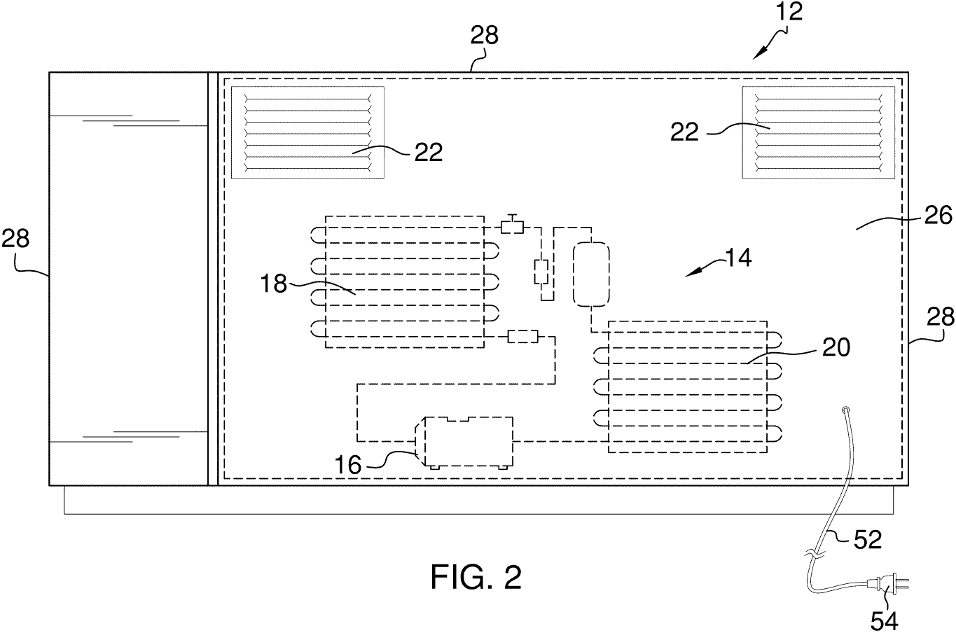

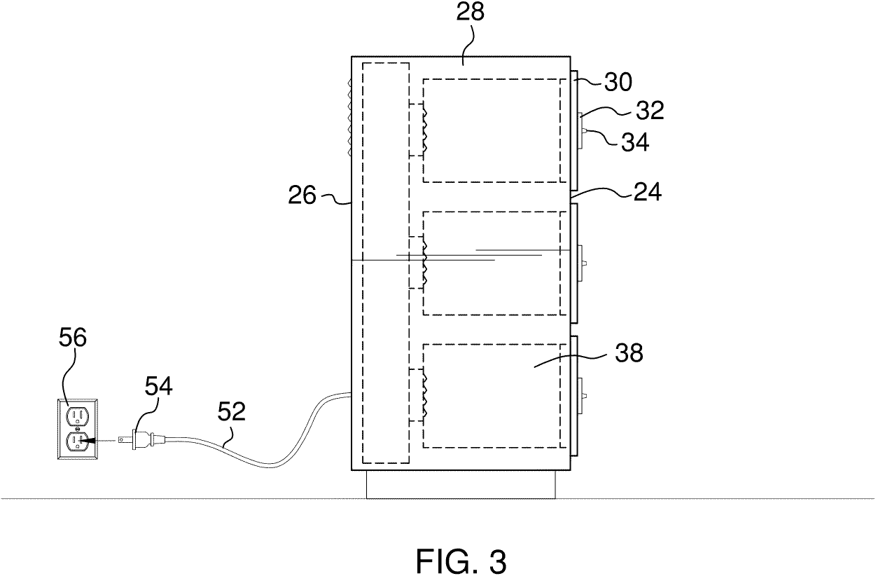

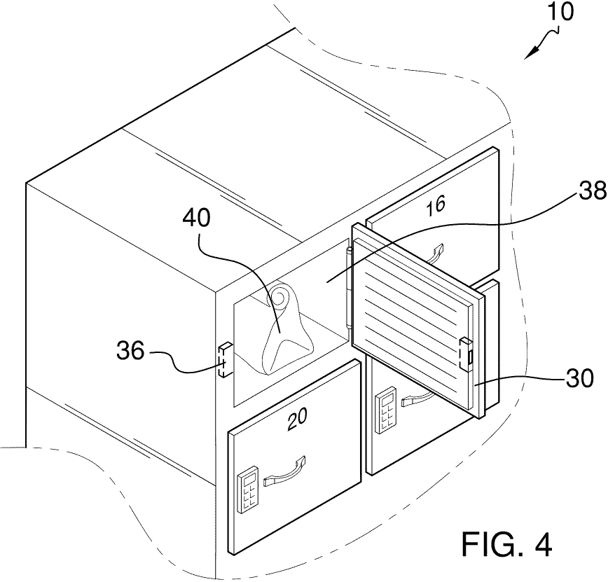

With reference now to the drawings, and in particular to FIGS. 1 through 4 thereof, a new refrigerated locker device embodying the principles and concepts of an embodiment of the disclosure and generally designated by the reference numeral 10 will be described.

As best illustrated in FIGS. 1 through 4, the electronic lock refrigeration assembly 10 generally comprises a refrigeration unit 12. The refrigeration unit 12 has a refrigeration system 14 being configured for cooling an interior of the refrigeration unit 12. The refrigeration system 14 can be an existing system including a compressor 16, condensation coils 18, evaporation coils 20, and vents 22 or fans.

The refrigeration unit 12 has a peripheral surface 24 and a back surface 26. The peripheral surface 24 is positioned facing the user when in-use. The peripheral surface 24 and back surface 26 are parallel relative to each other. Furthermore, the refrigeration unit 12 has a plurality of sides 28. Each of the sides 28 is positioned perpendicular relative to the peripheral surface 24 and the back surface 26.

A plurality of doors 30 is positioned on the peripheral surface 24 of the refrigeration unit 12. Each of the doors 30 has a key pad 32 and a handle 34. The handle 34 is a grip attached to each of the doors 30 and provides an area of the user to pull on the door 30. The key pad 32 is in electric communication with a locking mechanism 36 of each of the doors 30. The locking mechanism 36 is configured to unlock the door 30 when a correct code is entered into the key pad 32. The locking mechanism 36 can be an electronic lock such as an electromagnetic lock.

Each of the doors 30 has a cavity 38. The cavity 38 defines an area for a variety of items 40 to be stored within. The cavity 38 has a cubic shape and is configured to hold items to be cooled. The variety of items 40 can include food or beverages. The cavity 38 is enclosed by the door 30 and can be accessed when the door 30 is unlocked and opened. A locking system 42 positioned on the peripheral surface 24 of the refrigeration unit 12 controls the locking mechanism 36 of each of the doors 30. The locking system 42 is configured for assigning a key code 44 to the key pad 32 of each of the doors 30. The key code 40 is a set of randomized numbers to be entered in a specific order to unlock the door 30.

The locking system 42 includes a screen 46 and a pay pad 48. The screen 46 and pay pad 48 are positioned on the peripheral surface 24 of the refrigeration unit 12. The screen 46 is a computer of the locking system 42 and is configured for providing access to the user for engaging with the locking system 42. The screen 46 has touch screen properties wherein the user can touch the screen 46 to engage with the locking system 42. The user can select an open locker to use, wherein the locking system 42 assigns the key code 44 for the user to get in and out of the cavity 38 of the door 30.

Positioned proximate to the screen 46 is the pay pad 48. The pay pad 48 is an electronic payment pad. The pay pad 48 is configured for engaging with the user to obtain currency to use the refrigeration unit 12. The pay pad 48 has a card slot 50. The card slot 50 is configured for the user to insert a money card to pay for an open locker. The money card can be an existing item such as a debit card or a credit card. The pay pad 48 is in electric communication with the screen 46 wherein the screen 46 is notified of the payment to allow access to the user.

A power cord 52 is positioned on the back surface 26 of the refrigeration unit 12. The power cord 52 has an outlet plug 54 and is configured for plugging into an outlet plug in 56. The power cord 52 provides electrical power to the refrigeration unit 12.

In use, the user can insert the money card into the card slot 50 of the pay pad 48 to rent each of the doors 30. The user can select an open door from the screen 46, and a time frame of how long to have access to the door 30. The locking system 42 assigns a key code 44 to a door 30 and displays the key code 44 to the user on the screen 46. The user can enter the key code 44 into the key pad 32 of the door 30 to disengage the locking mechanism 36 of the door 30. The user can store a food or beverage item in the cavity 38 of the door 30 and shut the door 30 when finished storing items within the cavity 38. The door 30 will lock after ten seconds of being closed and can be reopened using the key code 44. The items within the cavity 38 will remained cooled by the refrigeration system 14 within the refrigeration unit 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A locking refrigeration unit assembly configured for having a plurality of doors to store food within, the assembly comprising:
a refrigeration unit having a refrigeration system, the refrigeration unit having a peripheral surface and a back surface;
a plurality of doors being positioned on the peripheral surface of the refrigeration unit, each of the doors having a key pad and a handle, each of the doors having a cavity, the plurality of doors being configured for enclosing the cavity of each of the doors;
a locking system being positioned on the peripheral surface of the refrigeration unit, the locking system including:
a screen being configured for being a computer of the locking system, the screen be configured for allowing the user to select an open locker to use; and
a pay pad being an electronic payment pad, the pay pad being in electric communication with the screen.

2. The locking refrigeration unit assembly of claim 1, further comprising the refrigeration system being configured for cooling an interior of the refrigeration unit, the interior being configured for storing a plurality of items to be cooled.

3. The locking refrigeration unit assembly of claim 1, further comprising the refrigeration unit having a plurality of sides, the plurality of sides being positioned perpendicular relative to the peripheral and back surfaces.

4. The locking refrigeration unit assembly of claim 1, further comprising the key pad of each of the doors being in electric communication with a lock of each of the doors, the handle being configured for opening the door.

5. The locking refrigeration unit assembly of claim 1, further comprising the cavity of each of the doors defining an area for a variety of items to be stored within.

6. The locking refrigeration unit assembly of claim 4, further comprising the locking system being configured for assigning a key code to the key pad of each of the doors.

7. The locking refrigeration unit assembly of claim 1, further comprising the screen having touch screen properties.

8. The locking refrigeration unit assembly of claim 7, further comprising the screen being in electric communication with the plurality of doors.

9. The locking refrigeration unit assembly of claim 1, further comprising the pay pad having a card slot, the card slot being configured for the user to insert a money card to pay for an open locker.

10. The locking refrigeration unit assembly of claim 1, further comprising a power cord being positioned on the back surface of the refrigeration unit, the power cord being configured for plugging into an outlet plug in, the power cord being configured for providing electrical power to the refrigeration unit.

11. A locking refrigeration unit assembly configured for having a plurality of doors to store food within, the assembly comprising:
a refrigeration unit having a refrigeration system, the refrigeration system being configured for cooling an interior of the refrigeration unit, the interior being configured for storing a plurality of items to be cooled, the refrigeration unit having a peripheral surface and a back surface, the refrigeration unit having a plurality of sides, the plurality of sides being positioned perpendicular relative to the peripheral and back surfaces;
a plurality of doors being positioned on the peripheral surface of the refrigeration unit, each of the doors having a key pad and a handle, the key pad of each of the doors being in electric communication with a lock of each of the doors, the handle being configured for opening the door, each of the doors having a cavity, the cavity of each of the doors defining an area for a variety of items to be stored within, the plurality of doors being configured for enclosing the cavity of each of the doors;
a locking system being positioned on the peripheral surface of the refrigeration unit, the locking system being configured for assigning a key code to the key pad of each of the doors, the locking system including:
a screen being configured for being a computer of the locking system, the screen having touch screen properties, the screen be configured for allowing the user to select an open locker to use, the screen being in electric communication with the plurality of doors; and
a pay pad being an electronic payment pad, the pay pad having a card slot, the card slot being configured for the user to insert a money card to pay for an open locker, the pay pad being in electric communication with the screen.
a power cord being positioned on the back surface of the refrigeration unit, the power cord being configured for plugging into an outlet plug in, the power cord being configured for providing electrical power to the refrigeration unit.
